(19) United States
(12) Patent Application Publication
(10) Pub. No.: US 2025/0264364 A1
(43) Pub. Date: Aug. 21, 2025

(54) LIQUID TEMPERATURE SENSOR APPARATUS

(71) Applicants: Kevin Wesley Gayleard, Mechanicsville, VA (US); Thomas Mitchel Bartholomew, Prince George, VA (US)

(72) Inventors: Kevin Wesley Gayleard, Mechanicsville, VA (US); Thomas Mitchel Bartholomew, Prince George, VA (US)

(21) Appl. No.: 19/060,155

(22) Filed: Feb. 21, 2025

Related U.S. Application Data
(60) Provisional application No. 63/556,217, filed on Feb. 21, 2024.

(51) Int. Cl. G01K 1/14; G01F 23/00; G01K 1/024; G01K 1/10; G01K 1/12; G01K 7/02; G01K 13/00

(52) U.S. Cl. CPC G01K 1/146; G01F 23/0023; G01K 1/024; G01K 1/10; G01K 1/12; G01K 13/00; G01K 7/02

(57) ABSTRACT

A liquid temperature sensor apparatus includes a liquid temperature sensor, a cable reel and a handheld display. The liquid temperature sensor may measure a liquid temperature. The cable reel may lower the liquid temperature sensor into a well including a liquid, and the handheld display may display the temperature of the liquid measured by the liquid temperature sensor.

### CROSS-REFERENCE TO RELATED APPLICATION

This application claims the benefit of priority of U.S. provisional application No. 63/556,217, filed Feb. 21, 2024, the contents of which are herein incorporated by reference.

### BACKGROUND OF THE INVENTION

The present invention relates to a liquid temperature sensor apparatus and, more particularly, to a liquid temperature sensor on a portable cable reel with a handheld display for landfill liquid temperature measurements.

It is known that temperatures in a landfill gas (LFG) well can reach above 180-215 degrees Fahrenheit. Currently, the waste industry lacks a device that can withstand the temperatures and reach the depths with recovery in LFG well pipes. Conventional temperature measurement devices do not have high-enough temperature capability and length of cable to efficiently measure liquid temperature in LFG wells. For example, the current devices in the market are not rated above 175° Fahrenheit and hence are not efficient in measuring temperatures in the LFG wells. Further, the current designs do not last and are not rugged enough for seasonal usage.

As can be seen, there is a need for a temperature measuring device/apparatus that can efficiently measure high temperatures in LFG wells.

### SUMMARY OF THE INVENTION

In one aspect of the present invention, a liquid temperature and level gauge comprises a temperature sensor configured to measure a liquid temperature; a cable joined to the temperature sensor; and a handheld instrument electronically connected to the liquid temperature sensor, the handheld instrument having a visual display vis configured to display the liquid temperature.

These and other features, aspects and advantages of the present invention will become better understood with reference to the following drawings, description, and claims.

### BRIEF DESCRIPTION OF THE DRAWINGS

FIG. 1 is a perspective view of a liquid temperature sensor according to an embodiment of the present invention;

FIG. 2 is a front elevation view thereof; and

FIG. 3 is a partial cutaway side view thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is an apparatus having a liquid temperature sensor mounted on a cable wound around a cable reel, as well as a handheld display. The liquid temperature sensor is operative to accurately measure an elevated liquid temperature. The handheld display displays the liquid temperature measured by the sensor.

The handheld display may communicate with the probe via a cable in some embodiments. In other embodiments, the handheld display may communicate with the probe wirelessly.

The liquid temperature sensor apparatus, as disclosed in the present disclosure, has a streamlined probe configuration for better insertion into, and recovery from, an LFG well. The apparatus is designed to be rugged to withstand the temperatures associated with a landfill gas well and to be used repeatedly for seasonal compliance testing. The apparatus accurately takes compliance temperature measurements in locations having extreme temperatures that would destroy currently available devices or otherwise exceed the currently available device range.

In a non-limiting example of a sensor according to an embodiment of the present invention, the device may have a wetted probe end of approximately 6″ overall in length from the spring guide to the tip. The wetted probe may include a weighted body starting after the spring guide at the end of the cable of approximately 4.5″ in length and about 0.675″ in length. The main sensing portion of the probe generally extends approximately 0.75″ past the weight and is about 0.25″ in diameter. It has a cylindrical capsule shape after a rubber wrapping has been applied.

The wetted apparatus components may be made of stainless steel to survive the harsh environment inside an LFG well. They are preferably rated for use from about room temperature to at least about 400° Fahrenheit. The cable may be manufactured from stainless steel interlocking cable armor over polytetrafluoroethylene (PTFE, commonly known as Teflon®) high-temperature polyvinyl chloride (PVC) coated wire, with stainless steel footage markers (although not limited to feet; they may indicate metric distance) and with a leader spring bonded to the cable using two-part epoxy adhesive for strength. The probe may have a sleeve cast from high temperature-resistant rubber for protection. The braided cable/probe overlay offers rub and/or wear protection and additional linear strength. The handheld device may have a glass cover to protect the display. The footage markers may be read manually.

A voltage regulator may convert direct current (DC) for power, and a voltage threshold board may open power if the voltage drops too low.

In some aspects, the transmitter elements may be interchangeable with similar elements, or the transmitter elements may be excluded if no temperature signal conversion is required.

During operation, the probe assembly may be lowered into the LFG well from the cable reel. As the cable is lowered, the depth in feet may be computed and the current temperatures may be monitored. When the probe assembly touches the liquid, it records the depth and temperature at the liquid line. The signals may be transmitted by wire into a controller which may display the signals on a human-machine interface (HMI), i.e., a user interface, or a visual panel display. Outputs from the controller may actuate a status indicator light on the apparatus. The controller/HMI unit or the panel display may log these signals and monitor/record any trend shown by the results.

A case assembly comprising a housing with a cable reel may be obtained from original equipment manufacturers (OEMs). The operator may wire an ON/OFF button and a cable connector to the apparatus. Transmitter assemblies may be programmed and assembled, and the operator may install electronics into an OEM handheld kit having a panel display programmed to display signals received from the transmitter. The apparatus may also be configured for wireless and cloud connectivity. A sensor may be coupled to a cable and the cable may be mounted to the cable reel. The operator may additionally connect the cable from the handheld device to the cable reel assembly and test the signal.

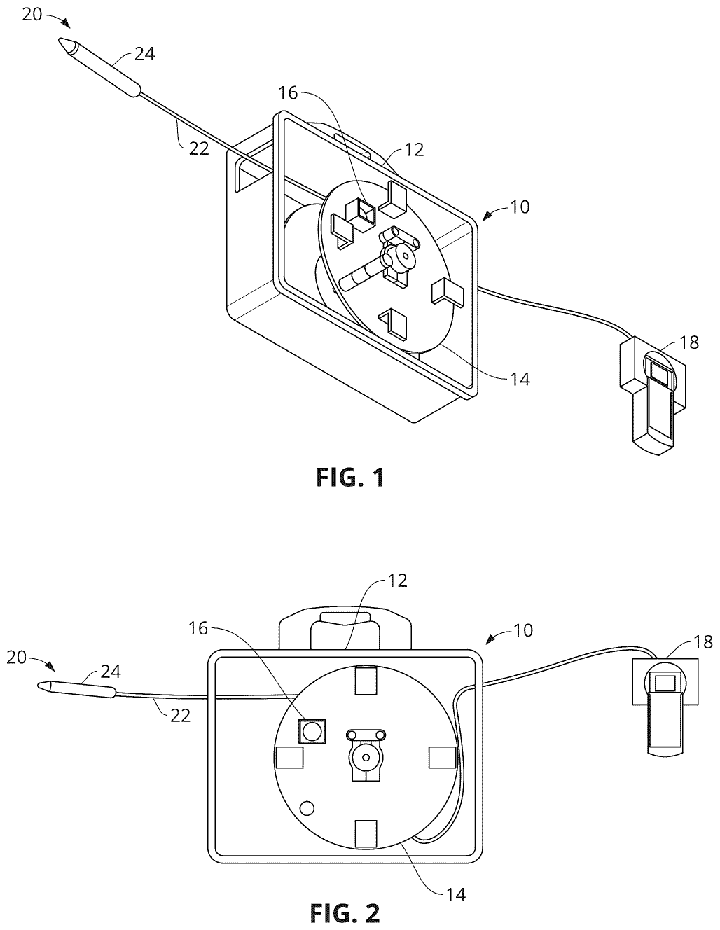

Referring to FIGS. 1-3, FIGS. 1 and 2 depict a liquid temperature sensor apparatus 10 in accordance with embodiments of the invention. Specifically, FIG. 1 depicts a perspective view of the apparatus 10 and FIG. 2 depicts a front view of the apparatus 10. The apparatus 10 may be configured to measure liquid temperature in a landfill gas (LFG) well. The apparatus 10 may include a protective case or housing 12 with a cable spool or reel 14 mounted rotatably within the housing 12. A temperature sensor or probe assembly 20 having a probe sleeve 24 may be coupled to an armored cable 22 wound around the reel 14. A handheld device 18 may include a panel display covered with a protective cover as well as a battery tray (not shown). A transmitter or transmitter assembly 16 may be mounted on the cable spool 14. The transmitter 16 may convert a digital temperature signal to an analog shown on the handheld 18 display. The signal from the probe may be transmitted via the cable in some embodiments. In other embodiments, the signal may be transmitted wirelessly.

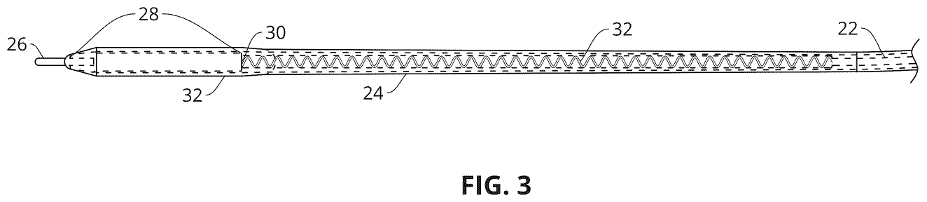

The probe body 30 shown in FIG. 3 may include a thermocouple 26 tip and a leader spring 32 bonded to the cable to prevent snags and help guide retrieval. Footage markers 28 crimped to the cable exhibit durability.

It should be understood, of course, that the foregoing relates to exemplary embodiments of the invention and that modifications may be made without departing from the spirit and scope of the invention as set forth in the following claims.

What is claimed is:

1. A liquid temperature and level gauge, comprising:
a temperature sensor configured to measure a liquid temperature;
a cable joined to the temperature sensor; and
a handheld instrument electronically connected to the liquid temperature sensor, the handheld instrument having a visual display vis configured to display the liquid temperature.

2. The liquid temperature and level gauge of claim 1, wherein the temperature sensor is configured as a probe comprising a thermocouple tip with a protective sleeve.

3. The liquid temperature sensor and level gauge of claim 1, wherein the cable further comprises a leader spring bonded thereto.

4. The liquid temperature sensor and level gauge of claim 1, wherein the cable further comprises depth markers crimped thereon.

5. The liquid temperature and level gauge of claim 1, further comprising a housing having a cord passage formed therethrough; and
a reel rotatably mounted within the housing, wherein the cable is wound about the reel in a storage position and extended through the cord passage in a use position.

6. The liquid temperature and level gauge of claim 1, further comprising a processor communicably coupled to the temperature sensor and the visual display, the processor including circuitry with program instructions to receive a signal from the temperature sensor, convert the signal from digital to analog, and deliver the signal to the visual display.

7. The liquid temperature and level gauge of claim 6, further comprising a user interface and/or a status indicator light, wherein the processor selectively actuates the user interface and/or the status indicator light responsive to the signal.

8. The liquid temperature and level gauge of claim 1, wherein the temperature sensor, the cable, and the visual display are provided with protective materials operative to resist extreme conditions selected from the group consisting of an acidic pH, a basic pH, a temperature of 212° F. to about 400°, contact with abrasive material, and any combination thereof.

9. The liquid temperature and level gauge of claim 8, wherein the protective materials are selected from the group consisting of: stainless steel, polytetrafluoroethylene coating, polyvinyl chloride coating, rubber, glass, and any combination thereof.

10. The liquid temperature and level gauge of claim 9, wherein the protective materials on the cable include a braided stainless steel interlocking cable armor.
